(19) United States
(12) Patent Application Publication
(10) Pub. No.: US 2004/0116080 A1
(43) Pub. Date: Jun. 17, 2004

(54) Time resolved RF plasma impedance meter

(75) Inventors: Chin-Hsiung Chen, Tanshuei Town (TW); Keh-Chyang Leou, Hsinchu (TW); Jia-Haur Chang, Hsinchu (TW)

Correspondence Address: Ladas & Parry, 26 West 61st Street, New York, NY, 10023, US

(73) Assignees: JIN-SHYONG CHEN; HAN-CHIUAN LUO

(21) Appl. No.: 10/178,381

(22) Filed: Jun. 24, 2002

(51) Int. Cl. H04B 1/04

(52) U.S. Cl. 455/115.1; 455/118

(57) ABSTRACT

A real time dynamic meter for measuring input impedance and power of an RF plasma is provided. The meter comprises a hardware portion and a software portion. The hardware portion comprises voltage and current detectors and a signal processing unit. The software portion comprises a signal retrieving and analyzing unit. The meter can analyze the relationship between the inputted power of the plasma and the density of the plasma, and can measure ion current of the RF bias inputted power and analyze plasma etching phenomenon, thus the yield rate can be improved. In addition, the meter can also be applied to monitor instability of the RF plasma. The occurrence and amount of the instability can be detected timely, therefore, physical and chemical mechanisms for detecting instability characteristics can be provided.

### BACKGROUND OF THE INVENTION

1. Field of the Invention

The present invention relates to a dynamic impedance meter, and more particularly, to a real-time dynamic impedance meter of radio frequency (RF) plasma.

2. Description of the Prior Art

RF plasma has been applied widely in physical vapor deposition, plasma-aided chemical vapor deposition, plasma etching technology, etc. Because the pulse plasma source can reduce the damage caused by plasma, it is much used in recent years. However, when the pulse plasma source is applied in the manufacturing process, the traditional impedance meter only can measure stable power and impedance, and the dynamic range is limited to under 10 Hz. Therefore, when the pulse frequency is over 1 KHz, the changing characteristic of plasma with high-changeability cannot be obtained.

In prior art, the function of the impedance meter is to measure stable power, i.e. limited in input power of slow-time varying. In U.S. Pat. Nos. 5,808,415 and 6,061,006, it is disclosed that after a detecting element obtains voltage and current signals, as 16 and 14 shown in FIG. 1, the signals are sampled and analyzed by a digital circuit when the RF impedance meter is used to measure the plasma. The disadvantage, of the conventional meter, in addition to unsuitable for the pulse plasma, is that the measured signals at the output terminal are directly processed as digital signals, so waves and spectrum of the voltage and current cannot be observed (the wave and spectrum provide heating operation mode, i.e. capacitive mode and inductive mode).

### SUMMARY OF THE INVENTION

It is therefore an objective of the present invention to provide a dynamic real-time meter of input impedance and power of RF plasma to solve the above mentioned problems.

The present invention provides an input power meter of pulse RF plasma. The pulse signals of the RF plasma can be any waves, such as square waves, sine waves, delta waves, or trapezoidal waves, the pulse frequency can be up to about 50 KHz, the duty cycle is between 0.0001%-100%, the maximum measured voltage is about 6000 V, the maximum measured current is about 30 A, the phase angle resolution is about 0.1 degree, and the RF frequency can be up to about 100 MHz. Besides, the meter is suitable for measuring RF bias power of wafer substrate. Furthermore, the meter also can analyze bias power of input voltages, currents, phases, and impedance of the plasma. In short, the present invention provides a method for measuring time-varying RF power and bias power and monitoring associated processes.

These objects and advantages of the present invention will no doubt become obvious to those of ordinary skill in the art after reviewing the following detailed description of the preferred embodiment that is illustrated in the various drawings.

### BRIEF DESCRIPTION OF THE DRAWINGS

FIG. 1 is a schematic diagram of a prior art impedance meter.

FIG. 2 is a schematic diagram of the impedance meter in accordance with the present invention.

FIG. 3 is a circuit diagram of the impedance meter in accordance with the present invention.

FIG. 4 illustrates various modulation waves generated by a first signal generator in accordance with the present invention for modulating RF signals generated by a second signal generator.

FIG. 5A illustrates the relationship between the modulated voltage signals of the pulse plasma and time, the input signals comprise different waves of 10 KHz (square waves, sine waves, delta waves, or trapezoidal waves) having a duty cycle of 50%.

FIG. 5B illustrates the relationship between the input voltage signals of the pulse plasma and time, the input signals comprise different waves of 10 KHz (square waves, sine waves, delta waves, or trapezoidal waves) having a duty cycle of 50%.

FIG. 5C illustrates the relationship between the input current signals of the pulse plasma and time, the input signals comprise different waves of 10 KHz (square waves, sine waves, delta waves, or trapezoidal waves) having a duty cycle of 50%.

FIG. 5D illustrates the relationship between the input impedance of the pulse plasma and time, the input signals comprise different waves of 10 KHz (square waves, sine waves, delta waves, or trapezoidal waves) having a duty cycle of 50%.

FIG. 5E illustrates the relationship between the power factors of the pulse plasma and time, the input signals comprise different waves of 10 KHz (square waves, sine waves, delta waves, or trapezoidal waves) having a duty cycle 50%.

FIG. 5F illustrates the relationship between the input power of the pulse plasma and time, the input signals comprise different waves of 10 KHz (square waves, sine waves, delta waves, or trapezoidal waves) having a duty cycle 50%.

FIG. 6A illustrates impedance meters applied in measuring RF voltage of unstable plasma.

FIG. 6B illustrates impedance meters applied in measuring RF current of unstable plasma.

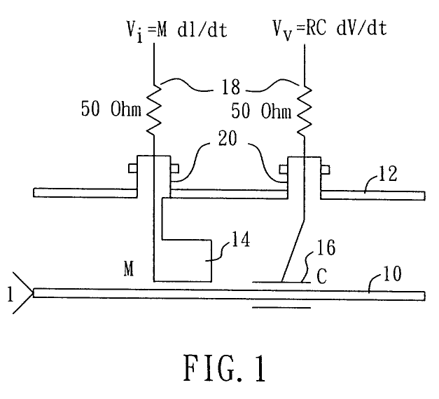

### DETAILED DESCRIPTION OF THE PREFERRED EMBODIMENT

Because the conventional RF impedance meter is unsuitable to measure pulse plasma, and it is hard to observe waves and spectrum of the signals, therefore, the present invention focuses on the pulse plasma and instability measuring, the latter can observe waves and spectrum of signals, this helps analyzing capacitive mode (E mode) and inductive mode (H mode). The architecture, circuit, principle, software, measurement, and result of the present invention are described as follows.

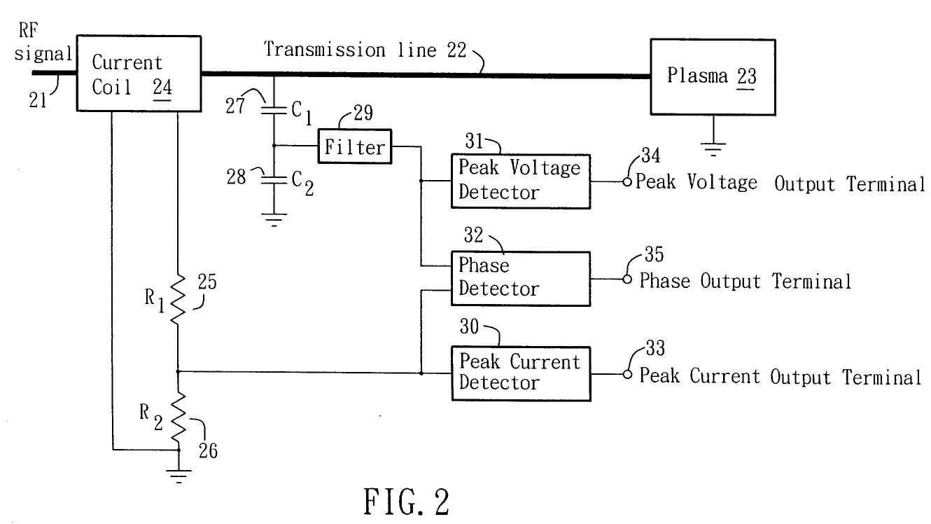

FIG. 2 is a schematic diagram of an impedance meter disclosed by the present invention. The impedance meter comprises a detector 24, such as a current coil, coupled to a signal to be measured, such as a plasma source, for detecting voltage and current of the signal. Voltage dividing resistors R₁ and R₂, as elements 25 and 26 shown in FIG. 2, are used to analyze and calculate actual RF current. Voltage dividing capacitors C₁ and C₂, as elements 27 and 28 shown in FIG. 2, are used to analyze and calculate actual RF voltage.

The impedance detector further comprises a peak detector coupled thereto, the peak detector comprises a peak current detector 30 and a peak voltage detector 31, for measuring peak values of voltage and current signals of the input signal. The output terminals of the peak current detector and the peak voltage detector are elements 33 and 34 (I, V), respectively.

Furthermore, to prevent RF signals from generating non-linear double-frequency signals and triple-frequency signals in plasma which cause errors in measurement, a filter 29, such as a low-frequency filter, can be used to achieve the effect.

The impedance detector further comprises a phase processing circuit 32 coupled to the peak detector for measuring and shifting phases of voltage and current signals. The phase processing circuit further comprises a power divider, a power attenuator, a phase detector, and a phase shifter. The output voltage detected by the phase processing circuit 32 can be converted to phases. The output terminal of the phase processing circuit 32 is element 35. The signal at the output terminal of the phase processing circuit 32 is proportional to the RF input power.

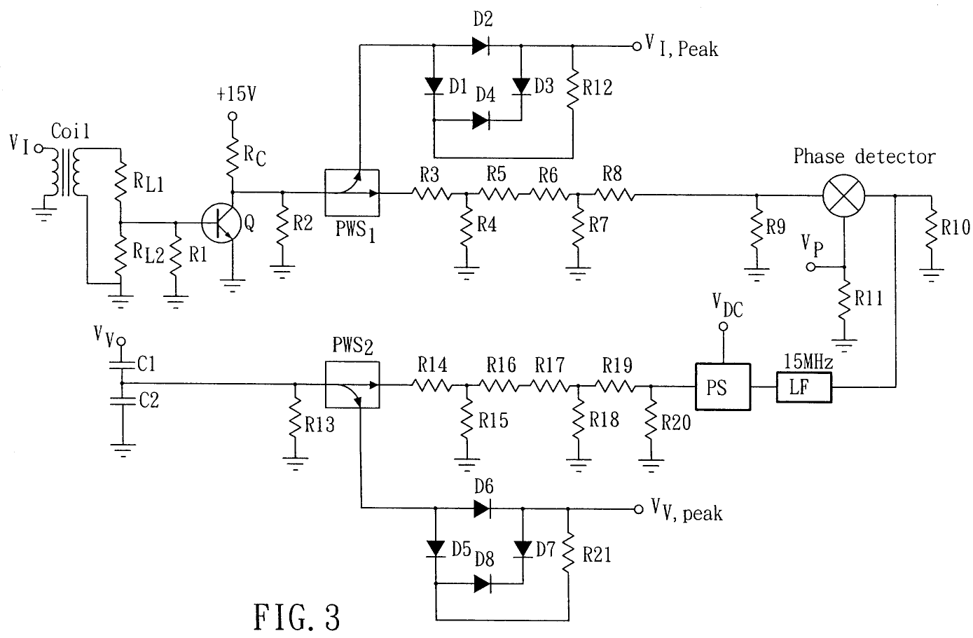

The circuit of the impedance meter is shown in FIG. 3 and is mainly consisted of:

1. RF peak current part: through the current detector and the resistors R_{L1} and R_{L2}, the voltage is divided then amplified by an amplifier (Q), a peak voltage is obtained by the power divider (PSW₁) and the peak detector formed by a rectifying circuit (D₁-D₄) and R₁₂, and the output terminal is V_{1, peak}.

2. RF peak voltage part: after voltage divided by the voltage detector C₁ and C₂, a peak voltage is obtained by the power divider (PSW₂) and the peak detector formed by a rectifying circuit (D₅-D₈) and R₂₁, and the output terminal is V_{V, peak}.

3. Phase part between RF voltage and RF current: using other signals divided by the powers dividers of items 1 and 2, a phase angle is measured by a power attenuator and a phase detector (PS), and the output terminal is V_{P}.

After the voltage, current, and phase of the plasma power are measured by the real-time impedance meter, input power and impedance can be calculated according to the following formulas:

P=1/2V·I·cos θ 1.1

$$Z = \frac{V}{I} = R + j X \qquad 1.2$$

R=|Z|cos θ, X=|Z| sin θ 1.3

wherein

| | |
|---|---|
| V: RF peak voltage, | I: RF peak current, |
| Θ: phase, | P: power, |
| Z: impedance, | R: resistor, |
| X: reactance | |

The former end of the RF impedance meter of the present invention further comprises an RF input power, and the RF input power is coupled to a signal generator. The signal generator is used to generate square waves, sine waves, delta waves, or trapezoidal waves with duty cycle between 0.0001% and 100%.

The present invention provides an input power meter of pulse RF plasma. The pulse signals of the RF plasma can be any waves, such as square waves, sine waves, delta waves, or trapezoidal waves, the pulse frequency can be up to about 50 KHz, the duty cycle is between 0.0001%-100%, the maximum measured voltage is about 6000 V, the maximum measured current is about 30 A, the phase angle resolution is about 0.1 degree, and the RF frequency can be up to about 100 MHz. Besides, the meter is suitable for measuring RF bias power of wafer substrate. Furthermore, the meter also can analyze input voltages, currents, phases, and impedance of the plasma. The present invention also provides a method for increasing time-varying dynamic range. This method helps measuring the characteristic of pulse RF plasma and monitoring associated processes by much.

The present invention also discloses to a method for measuring RF impedance. The signals to be measured are detected by the peak detector and processed by the phase processing circuit, then sampled and forwarded to a computer by an analog-to-digital converter. The function of signals retrieving and analyzing comprises retrieving signals, calculating, analyzing, and correcting. The operation is described as follows:

(1) Select inode:

a. RF Plasma mode: CW mode, TM mode.

b. Power attenuation rate.

(2) Save file: comprising records of power and time.

(3) Real-time data measuring and demo space: comprising the magnitudes of RF voltage, current, impedance, phase, and power.

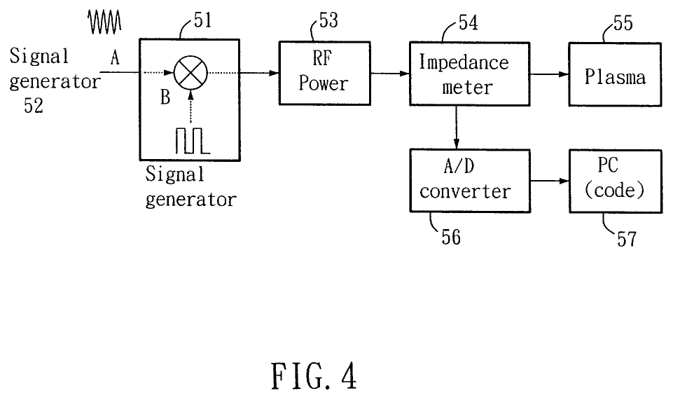

The measuring system is shown in FIG. 4. Each kind of waves (10 KHz) outputted by the first signal generator 51 is treated as modulated signals, as shown at B in FIG. 4. A signal generator 52 outputs sine-wave RF signals, as shown at A in FIG. 4. The modulated signals comprise four signals, square-waves (Rec), sine-waves (Sine), delta-waves (Tri), and trapezoidal-waves (Trape), whose duty cycle is between 0.0001%-100% (50% in the preferred embodiment). The impedance meter 54 is connected to the power output terminal of RF power supply 53. The outputs of the impedance meter 54 are coupled to the plasma 55 and A/D converter 56, respectively. Then the A/D converter transmits the converted result to the processor 57.

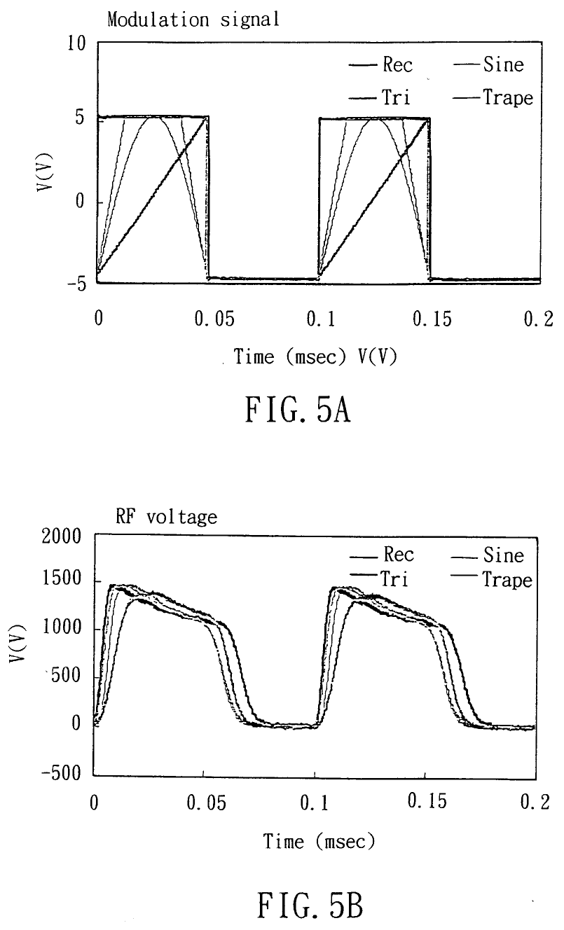

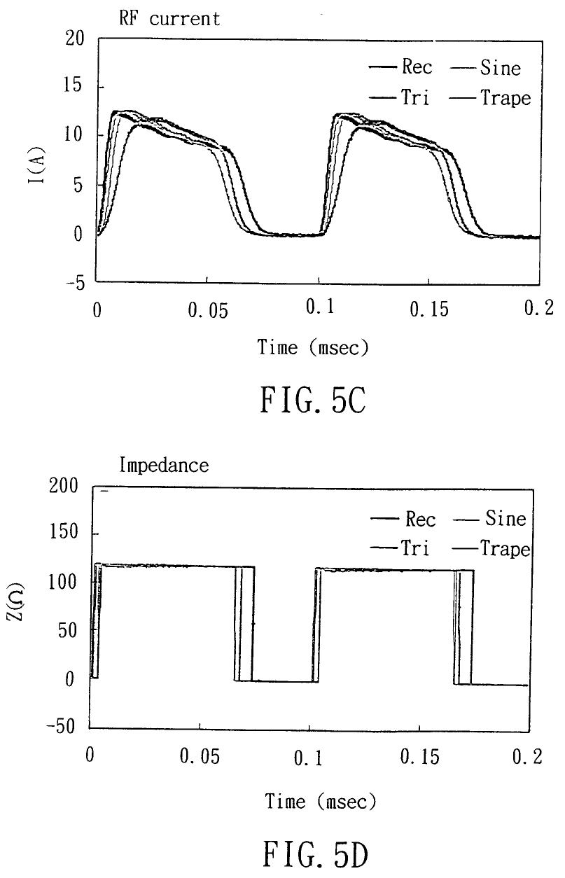

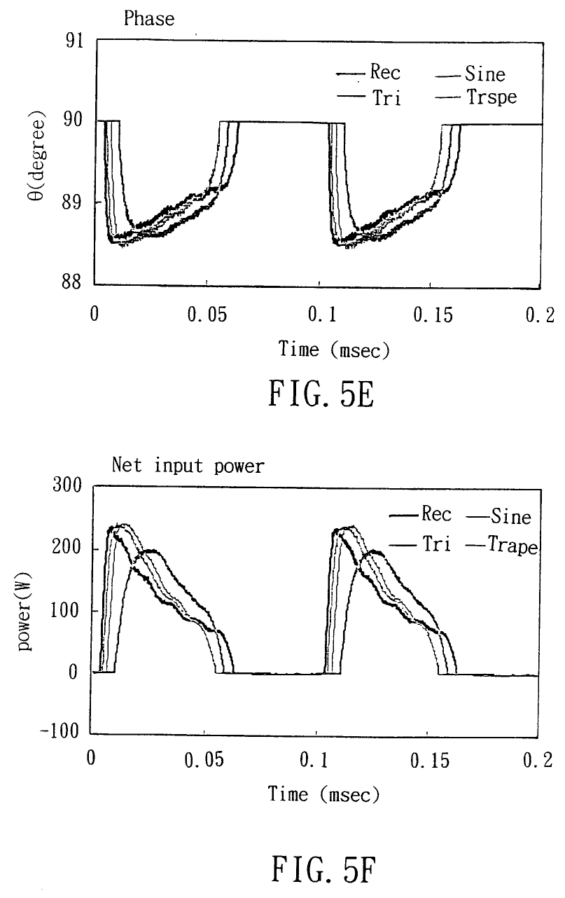

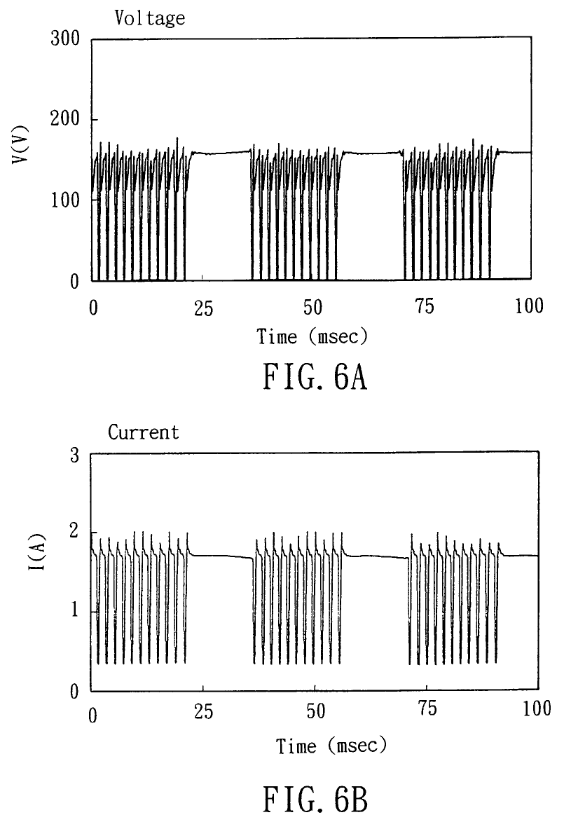

The measured result is shown in FIG. 5. FIG. 5A illustrates waves of modulated signals (signals after modulated), i.e. pulse signals. FIGS. 5B and 5C illustrate the voltage wave and current waves measured and calculated by the impedance meter. When the input RF plasma power is activated, the sequence of raising time of voltage and current signals is delta-wave, sine-wave, trapezoidal-wave, and square-wave. When the input RF plasma power is turned off, the sequence of descending time is square-wave, delta-wave, trapezoidal-wave, and sine-wave. FIGS. 5D and 5E show the values of impedance and phase changing by time. FIG. 5F shows the input power of RF plasma. The test of each kind of 10 KHz pulse plasma shows the ability of the impedance meter disclosed by the present invention. On the other hand, the impedance meter disclosed by the present invention can also apply in monitoring instability of RF plasma. The instability of RF plasma mainly appears in electronegative discharging and has a significant effect to the instability of the plasma process. Therefore, in monitoring, if the occurrence and amount of the instability can be detected in real-time, the yield rate of the process can be significantly improved. The agitation frequency of the instability is typically under 10 KHz, so the impedance meter of the present invention can also be used to measure the instability of plasma. FIG. 6 shows an instability measurement of chloration plasma. It shows that voltage and current signals have a phenomenon of agitation of double-period to time.

In summary, the advantages of the present invention are: 1) providing a real-time dynamic impedance meter to obtain relationship among plasma input power, impedance, and time; and 2) capable of applying to measure bias power of wafer substrate in plasma process and suitable to dynamically analyze ion energy.

Those skilled in the art will readily observe that numerous modifications and alterations of the invention may be made while retaining the teachings of the invention. Accordingly, it is intended to embrace all such modifications and alternations as fall within the spirit and scope of the appended claims.

What is claimed is:

1. An RF impedance meter comprising:
a detector coupled to a signal to be measured for detecting voltage and current signals of the signal to be measured;
a peak detector coupled to the detector for measuring peak values of the voltage and current signals; and
a phase processing circuit coupled to the peak detector for measuring and shifting phases of the voltage and current signals to obtain an RF impedance.

2. The RF impedance meter of claim 1, wherein the RF impedance meter is used to dynamically and timely measure RF impedance or power of an RF plasma.

3. The RF impedance meter of claim 1, wherein the detector is a current coil.

4. The RF impedance meter of claim 1, wherein the detector uses capacitors and resistors to divide and calculate the values of the voltage and current signals.

5. The RF impedance meter of claim 1, wherein the peak detector further comprises a power divider, an attenuator, and a rectifying circuit.

6. The RF impedance meter of claim 1, wherein the phase processing circuit further comprises a power divider, a power attenuator, a phase detector, and a phase shifter.

7. The RF impedance meter of claim 1, further comprising a filter to prevent errors caused by other hormonic frequency signals.

8. The RF impedance meter of claim 7, wherein the filter is a low frequency filter.

9. The RF impedance meter of claim 1, further comprising an amplifier for amplifying signals detected by the detector.

10. The RF impedance meter of claim 1, wherein the maximum of the measured voltage is about 6000 V.

11. The RF impedance meter of claim 1, wherein the maximum of the measured current is about 30 A.

12. The RF impedance meter of claim 1, wherein the maximum of the measured phase angle resolution is about 0.1 degree.

13. The RF impedance meter of claim 1, wherein the maximum of pulse frequency of the plasma is about 50 KHz.

14. The RF impedance meter of claim 1, further comprising an RF input source whose maximum frequency is about 100 MHz.

15. The RF impedance meter of claim 14, wherein the RF input source is coupled to a signal generator whose input signal is square wave, sine wave, delta wave, or trapezoidal wave having a duty cycle of about 0.0001% to 100%.

16. A measuring system for RF impedance comprising:
a first signal generator for generating a specific wave signal to modulate an input signal generated by a second signal generator;
an Rf source coupled to the modulated input signal and outputting an RF input signal;
a meter coupled to the RF input signal and a signal source to be measured and outputting a measured result;
a converter coupled to the meter for converting the measured result to signals in another form; and
a processor coupled to the converter for processing the converted signals.

17. The system of claim 16, wherein the wave signal is square wave, sine wave, delta wave, or trapezoidal wave having a duty cycle of about 0.0001% to 100%.

18. A measuring method for RF impedance comprising steps of
(a) using a detector to detect voltage and current signals of a signal to be measured;
(b) using a peak detector to measure peak values of the detected voltage and current signals;
(c) using a phase processing circuit to measure and shift phases of the peak voltage and peak current;
(d) using a converter to retrieve and convert the processed phase signals; and
(e) using a processor to calculate and analyze the converted signals to obtain an RF impedance.

19. The method of claim 18, further comprising a step of using a first signal generator to generate a specific wave signal and modulate an input signal generated by a second signal generator.

20. The method of claim 18, further comprising a step of calculating RF power.
